(19) United States
(12) Patent Application Publication
(10) Pub. No.: US 2022/0151431 A1
(43) Pub. Date: May 19, 2022

(54) MACHINE VISION COOK TIMER

(71) Applicant: Haier US Appliance Solutions, Inc., Wilmington, DE (US)

(72) Inventors: Bobby Lee Lindsey, Louisville, KY (US); John Gilman Chapman, JR., Louisville, KY (US); Nelson Tanquero, Louisville, KY (US); Michael Goodman Schroeder, Louisville, KY (US); Matthew Hendrix, Louisville, KY (US)

(21) Appl. No.: 16/951,055

(22) Filed: Nov. 18, 2020

(51) Int. Cl. A47J 36/32; F24C 7/08; F24C 3/12; H05B 6/64

(52) U.S. Cl. CPC A47J 36/321; H05B 6/6447; F24C 3/128; F24C 7/085

(57) ABSTRACT

A cooking appliance includes a cabinet defining a cooking chamber, a door configured to open and close the cooking chamber, a heating element configured to provide heat to the cooking chamber, a camera directed at the cooking chamber, and a controller operably connected to the camera. The controller is configured to initiate a cooking operation including determining that the door is in a closed position, capturing a first image of the cooking chamber using the camera, determining an occupied state of the cooking chamber based on the first image, and initiating a timer sequence upon determining the occupied state of the cavity.

### FIELD OF THE INVENTION

The present subject matter relates generally to oven appliances, and more particularly to intelligent timer sequences in oven appliances.

### BACKGROUND OF THE INVENTION

Oven appliances generally include a cabinet that defines a cooking chamber for cooking food items therein, such as by baking or broiling the food items. In order to perform the cooking operation, oven appliances typically include one or more heat sources, or heating elements, provided in various locations within the cooking chamber. Conventional oven appliances may also include built-in timers that allow users to enter in a cooking time to keep track of how long food has been in cooking.

However, conventional ovens require a user to manually enter in a cook time into the timer and monitor the timer throughout the cooking operation. Further, if the user removes the food item from the cooking chamber, the timer does not pause, leading to inaccurate cooking times and potentially undercooked foods. Additionally, if a user forgets to start a timer after placing food in the cooking chamber, an inaccurate cooking time may be measured, leading to potentially undercooked or overcooked foods.

Accordingly, an oven appliance that obviates one or more of these drawbacks would be beneficial. Particularly, an oven appliance that is able to intelligently initiate and pause a timer, and a method of operating an oven appliance capable of the same would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet defining a cooking chamber, a door configured to open and close the cooking chamber, a heating element configured to provide heat to the cooking chamber, a camera directed at the cooking chamber, and a controller operably connected to the camera. The controller may be configured to initiate a cooking operation including the steps of determining that the door is in a closed position, capturing a first image of the cooking chamber using the camera, determining an occupied state of the cooking chamber based on the first image, and initiating a timer sequence upon determining the occupied state of the cavity.

In another exemplary aspect of the present disclosure, a method of operating a cooking appliance including a cooking chamber and a camera is provided. The method may include determining that a door of the cooking chamber is in a closed position, capturing a first image of the cooking chamber using the camera, analyzing the first image, determining an occupied state of the cooking chamber based on the first image, and initiating a timer sequence upon determining the occupied state of the cooking chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance with the door in a closed position according to exemplary embodiments of the present disclosure.

FIG. 2 provides a front view of an interior of a cooking chamber of an exemplary oven appliance according to exemplary embodiments of the present disclosure.

FIG. 3 provides a flow chart illustrating a method of operating an oven appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

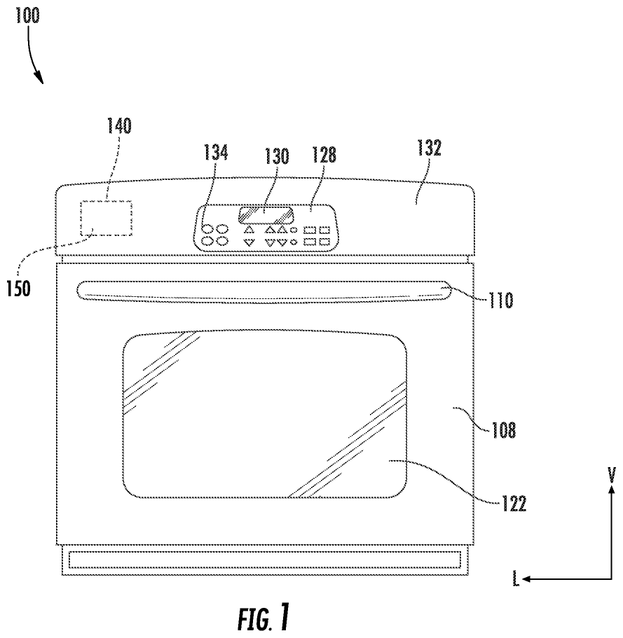

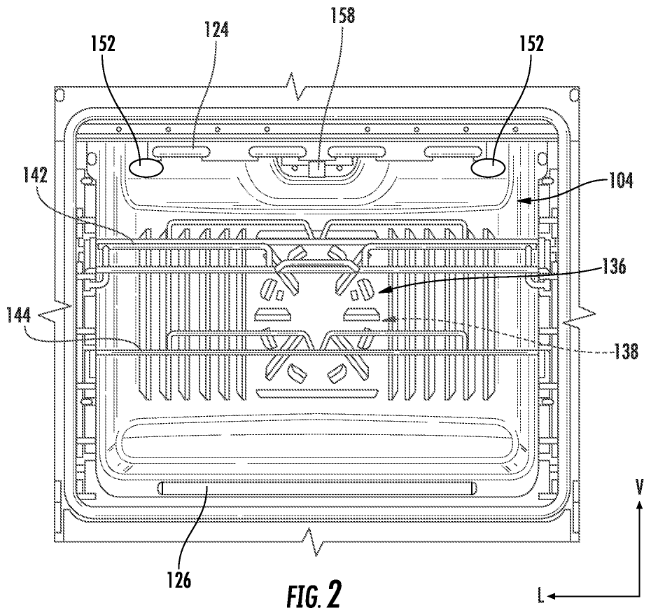

Referring to FIGS. 1 and 2, for this exemplary embodiment, oven appliance 100 may include an insulated cabinet 102 with an interior cooking chamber 104 defined by a top wall 112, a bottom wall 114, a back wall 116, and a pair of opposing side walls 118. As shown in FIG. 1, door 108 is in a closed position (i.e., cabinet 102 is sealed). Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 may be mounted to door 108 to assist a user with opening and closing door 108. For example, a user can pull on handle 110 to open or close door 108 and access cooking chamber 104.

Oven appliance 100 may include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack may be positioned in cooking chamber 104 for the receipt of food items or utensils containing food items. For example, the cooking chamber may include a first baking rack 142 and a second baking rack 144. Each of first baking rack 142 and second baking rack may be conveniently moved into and out of cooking chamber 104 when door 108 is open (i.e., via rails provided on each of side walls 118). First baking rack 142 may be arranged above second baking rack 144 (e.g., in the vertical direction V). Thus, first baking rack 142 may be closer to top wall 112 of cabinet 102 than second baking rack 144.

One or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, oven appliance 100 includes a top heating element 124 and a bottom heating element 126. Bottom heating element 126 may be incorporated in addition or alternatively to the top heating element 124.

Oven appliance 100 may also have a convection heating element 136 and convection fan 138 positioned adjacent back wall 116 of cooking chamber 104. Convection fan 138 may be powered by a convection fan motor. Further, convection fan 138 may be a variable speed fan—meaning the speed of fan 138 may be controlled or set anywhere between and including, e.g., zero and one hundred percent (0%-100%). In certain embodiments, oven appliance 100 also includes a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 may be determined by controller 140. In addition, a sensor such as a rotary encoder, a Hall effect sensor, or the like, may be included at the base of fan 138 to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Oven appliance 100 may include a user interface 128 having a display 130 positioned on an interface panel 132 and having a variety of user input devices, e.g., controls 134. Interface 128 may allow the user to select various options for the operation of oven 100 including, e.g., various cooking and cleaning cycles. Operation of oven appliance 100 may be regulated by a controller 140 that is operatively coupled, i.e., in communication with, user interface 128, heating elements 124, 126, 136 and other components of oven 100 as will be further described.

For example, in response to user manipulation of the user interface 128, controller 140 may operate the heating element(s) 124, 126, and/or 136. Controller 140 may receive measurements from one or more temperature sensors such as sensors described below. Controller 140 may also provide information such as a status indicator, e.g., a temperature indication, to the user with display 130. Controller 140 may also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory may store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen, which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface with a display thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

Oven appliance 100 may further include a timer 150. For instance, timer 150 may be programmed into controller 140, as would be understood. Timer 150 may be operably connected with door 108 and camera 158 and configured to operate based on the actions or operations of door 108 and/or camera 158. For example, oven appliance 100 may determine when door 108 is in a closed position and automatically start the timer 150. In some embodiments, oven appliance determines that door 108 is in an open position (e.g., as shown in FIG. 2) and pauses the timer 150. In still another embodiment, oven appliance determines an occupied state of the cooking chamber (e.g., via camera 158) and initiates a timer sequence on timer 150. A further explanation of an operation of timer 150 will be explained in detail below.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

As shown in FIG. 2, door 108 of oven appliance 100 is in an open position. It should be understood that “open” is generally understood as being moved apart from a closed position (FIG. 1) and may not mean fully open (e.g., door 108 at full extension). Thus, the open position may include varying degrees of openness. For instance, the open position may include door 108 being one quarter open, half open, three-quarters open, etc. Cooking chamber 104 may include one or more heating zones. It should be understood that any suitable number of heating zones may be incorporated into cooking chamber 104, including more or less than three heating zones. Each of the heating zones may be spaced apart from one another (e.g., along one or more mutually-orthogonal directions, such as the vertical direction V, the lateral direction L, and/or transverse direction). Accordingly, each heating zone may be controlled separately from one another (e.g., to or at a different temperature or power level, using a different criterion, or using a different heating cycle).

Oven appliance 100 may further include an oven light 152. Oven light 152 may be located within cooking chamber 104. Oven light 152 may be configured to illuminate cooking chamber 104 at certain times (e.g., when the door is in the open position, when food is cooking, etc.). Oven light 152 may include a plurality of oven lights spaced apart within cooking chamber 104. In some embodiments, oven light 152 is positioned outside of cooking chamber 104 and directed toward the interior of cooking chamber 104. A location or locations of oven light 152 may vary according to embodiments and applications, and a specific location or locations of oven light 152 is not limited to that shown in FIG. 2.

A camera 158 may be provided within cooking chamber 104. In some embodiments, multiple cameras 158 are provided within cooking chamber 104. Generally, camera 158 may be a video camera or a digital camera with an electronic image sensor [e.g., a charge coupled device (CCD) or a CMOS sensor]. When assembled, camera 158 is in communication (e.g., electric or wireless communication) with controller 140 such that controller 140 may receive a signal from camera 158 corresponding to the image captured by camera 158. Camera 158 may be configured to capture images of cooking chamber 104 (e.g., an interior of cabinet 102). For instance, camera 158 may capture images of food items placed in each of first heating zone, second heating zone, and/or third heating zone. Camera 158 may be located in any suitable location within cooking chamber 104, such that cooking chamber 104 is visible to camera 158. For example, as shown in FIG. 2, camera 158 may be located at or near a top of cooking chamber 104 in the vertical direction V (e.g., adjacent to top heating element 124). Additionally or alternatively, camera 158 may be located at or near a center of cooking chamber 104 in the lateral direction L. The specific location of camera 158 is not limited, however, and one of ordinary skill in the art would appreciate multiple potential locations for camera 158.

Additionally or alternatively, multiple cameras 158 may be provided within cooking chamber 104. For example, each camera 158 may be directed toward a different heating zone, such that multiple heating zones may be more easily monitored simultaneously. Further, each camera 158 may start a separate timer 150 associated with a corresponding heating zone. In other words, each camera 158 may be associated with an individual heating zone and an individual timer 150. Accordingly, each camera 158 may monitor its associated heating zone and operate its associated timer 150 to monitor distinct items in the heating zones. In some embodiments, controller 140 assigns a timer name to respective timers 150 in individual heating zones. For example, a first heating zone may have a camera 158 and a timer 150 which may be referred to as a “cookie timer,” when camera 158 determines that cookies are present within the first heating zone.

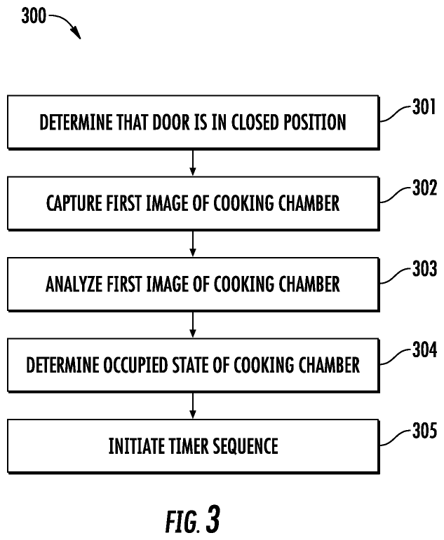

FIG. 3 is a flowchart describing a method 300 of operating a cooking appliance (or cooking operation). For example, the method 300 described herein with respect to FIG. 3 may be used to operate the cooking appliance described above with respect to FIGS. 1 and 2. Additionally or alternatively, the method 300 described herein with respect to FIG. 3 may be used to operate other suitable cooking appliances.

At step 301, the method 300 may include determining that the door is in a closed position (i.e., an opening of a cooking chamber of the oven appliance is sealed by the door). The oven appliance (such as oven appliance 100, for example) may determine the position of the door in a number of ways. For instance, a sensor may be attached to the door and configured to detect a position of the door (e.g., open or closed). For instance, the sensor may be include or be provided as an accelerometer or gyroscope mounted on the door, as would be understood. Additionally or alternatively, the sensor may include or be provided as a contact or engagement switch selectively engaged with the cabinet at the closed position. In some embodiments, the oven appliance uses a camera (e.g., camera 158) to determine the position of the door. For instance, the camera may capture an image including the door and transmit the image to the controller for analysis. The controller may then analyze the image to determine a position of the door. In some embodiments, the controller analyzes the image to determine whether the door is in contact with the opening of the cooking chamber. Other sequences may further be used to determine the position of the door based on one or more images obtained by the camera, as would be understood. Additionally or alternatively, the controller may direct the camera to capture the image of the cooking chamber upon a start of a cooking cycle as initiated by a user. For example, when a user presses a “start” button on a control panel, the camera may capture the image of the cooking chamber.

At step 302, the method 300 may include capturing a first image of a cooking chamber. In detail, in response to determining that the door is in a closed position, a controller of the oven appliance may direct the camera (e.g., camera 158) to capture an image of the cooking chamber (e.g., an interior of the oven appliance). In some embodiments, the camera captures a plurality of images. The image or images captured by the camera may be transmitted to the controller. In some embodiments, the camera may perform a preliminary processing of the image before transmitting the image to the controller.

At step 303, the method 300 may include analyzing the first image of the cooking chamber. The controller may perform an analysis of the image to determine a presence of food within the cooking chamber. For instance, the controller may utilize a machine vision algorithm to detect an item (e.g., a food item) within the cooking chamber. The machine vision algorithm may include an artificial intelligence (AI) system, such as a neural network, to analyze the image and determine the presence of the item. Additionally or alternatively, analyzing and determining the presence of such items, may be performed by edge matching, divide-and-conquer search, greyscale matching, histograms of receptive field responses, or another suitable routine, such as a spectral analysis, density analysis, infrared heat analysis, etc. In some embodiments, the machine vision algorithm is performed locally (i.e., within the oven appliance). In other embodiments, the machine vision algorithm is performed over a network (e.g., in a cloud computing space, for example). The controller may utilize any suitable method of detection available via the camera, such as spectral analysis, density analysis, infrared heat analysis, or other optical imaging techniques.

At step 304, the method 300 may include determining an occupied state of the cooking chamber. In response to performing the analysis of the first image, the controller may determine that the cooking chamber is in an occupied state. In other words, the controller may determine that an item (e.g., a food item) is present within the cooking chamber based on the analysis at 303. For instance, the neural network may scan the first image to determine the presence of the item within the cooking chamber. Additionally or alternatively, the controller may simultaneously perform analysis of multiple images captured by multiple cameras within the cooking chamber. Additionally or alternatively, the controller may instruct the camera (or cameras) to capture additional images when the controller is unable to determine an occupied or unoccupied state of the cooking chamber (or heating zone). Additionally or alternatively, the camera (or cameras) may capture additional images when the controller is unable to determine a type of food or item within the cooking chamber or heating zone.

At step 305, the method 300 may include initiating a timer sequence. In response to determining an occupied state of the cooking chamber (i.e., detecting an item within the cooking chamber), the controller may initiate a timer sequence. In some embodiments, the timer sequence is a count-down timer. For example, a user may input a specific cook time into the controller via a manual input (e.g., user interface 128) before opening the door to the cooking chamber. Additionally or alternatively, the user may input the cook time while the door is in the open position. Accordingly, the timer sequence may begin in response to the controller determining that the door is in the closed position and the controller has determined the occupied state of the cooking chamber.

In some embodiments, the controller also monitors a temperature of the cooking chamber. For instance, the camera may capture an infrared image of the cooking chamber which the controller may then analyze and determine an interior temperature of the cooking chamber. This captured image may be the same as or different from the image captured in step 302. In some embodiments, a temperature sensor provided within the cooking chamber may sense the temperature within the cooking chamber and transmit the sensed temperature to the controller. For instance, the temperature sensor may continually monitor the temperature within the cooking chamber (i.e., may take temperature readings at predetermined intervals) and transmit the temperature readings to the controller. Consequently, the controller may compare the determined interior temperature with a set temperature input by the user and determine a difference. The controller may then delay a start of the timer until the interior temperature of the cooking chamber matches the set temperature. Advantageously, a more accurate cooking time can be achieved, and time spent in a pre-heat stage can be disregarded in the timer sequence.

In some embodiments, the timer sequence is a count-up sequence. In detail, a user may omit entering a cook time when placing the food item in the cooking chamber. In this instance, the timer sequence may automatically begin a count-up timer upon determining that the door is in the closed position and the cooking chamber is in the occupied state. The controller may alert the user to the lack of a cook timer input. For instance, the oven appliance may output a tone or noise signal, or may flash lights on a display to alert the user. Subsequently, a user may enter in a cook time after having inserted the food item into the cooking chamber and moved the door to the closed position. The controller may automatically subtract the amount of time measured during the count-up sequence from the manually input cook time. Accordingly, a more accurate cooking time may be established. Additionally or alternatively, the subtraction of the count-up sequence may be combined with the delay during the preheating segment to produce an accurate cooking time.

The cooking operation may further include determining movement of the door from the open position to the closed position following 304 or 305. For instance, a door sensor may sense that the door has been moved from the open position to the closed position. In some embodiments, this is determined after the door has been determined to be in the closed position and the cooking chamber has been determined to be in an occupied state. Accordingly, the door sensor may sense that the door has been opened and closed after determining that the cooking chamber is in the occupied state.

The cooking operation may further include capturing a second image of the cooking chamber using the camera based on determining the movement of the door from the open position to the closed position. In detail, after determining that the door is again in the closed position, the camera may capture a second image of the cooking chamber. The second image may be similar to the first image as described above, and accordingly, a detailed description thereof is omitted. The camera may then transmit the second image to the controller.

The cooking operation may further include determining an unoccupied state of the cooking chamber. In detail, the controller may analyze the second image to determine whether or not the food item is in the cooking chamber. As mentioned above, the controller may utilize any suitable method to analyze the second image, such as object detection, density detection, moisture content, or the like. The unoccupied state of the cooking chamber may mean that no food item is present within the cooking chamber after the door is moved to the closed position. However, in some embodiments, the unoccupied state of the cooking chamber includes a presence of a cooking utensil (e.g., a pizza stone, a basting tray, etc.). For instance, the controller may analyze any one of the captured images and find the cooking utensil present within the cooking chamber, but no food present on or in the cooking utensil.

The cooking operation may further include stopping the timer sequence upon determining the unoccupied state of the cooking chamber. For instance, after the door has been moved to the closed position, the second image has been captured and analyzed, and no food item is present within the cooking chamber, the controller may pause the timer sequence previously started. Accordingly, a true cooking time may be maintained, with the pause included for the time that the food item was not in the cooking chamber. Advantageously, a more accurate cooking time may be realized.

The cooking operation may further include determining movement of the door from the open position to the closed position for a second time. For instance, the controller may note each time the door is opened and closed during a cooking operation. Subsequently, the camera may capture a third image (or any subsequent number of images for each time the door is opened and closed). For each image captured, the controller may perform an analysis of the image and determine whether the cooking chamber is in the occupied state (i.e., occupied with a food item) or the unoccupied state (i.e., no food item present). Each time the occupied state is determined, the controller may initiate (or reinitiate) the timer sequence accordingly.

The cooking operation may further include illuminating an oven light in response to determining the occupied state of the cooking chamber. In detail, the cooking chamber may include an oven light (e.g., oven light 152). Upon determining that the cooking chamber is in the occupied state (i.e., occupied with a food item), the controller may automatically activate (e.g., send power to) the oven light. Accordingly, the cooking chamber may be illuminated any time the cooking chamber is determined to be in the occupied state. Advantageously, a user may easily observe the food item within the cooking chamber. Additionally or alternatively, the cooking operation may include deactivating (e.g., ceasing a supply of power to) the oven light when the cooking chamber is deemed to be in the unoccupied state. Accordingly, the cooking chamber is not illuminated unnecessarily, thus saving power costs and light bulb life.

In some embodiments, the cooking operation includes determining an unoccupied state of the cooking chamber in response to analyzing a captured image after activation of a heating element. In detail, a user may activate the heating element to heat the cooking chamber. It should be understood that the activation of the heating element may be tied to an activation of the cooking cycle. Additionally or alternatively, an activation of the heating element may include a cycling of the heating element between an “on” state and an “off” state (i.e., the heating element emitting heat and the heating element not emitting heat). The camera may capture an image in response to the activation of the heating element (or the activation of a cooking cycle or the cooking operation). In some embodiments, this image is captured before the image captured in step 302. In some embodiments, this image is the same as the image captured in step 302. The controller may analyze the image and determine that the cooking chamber is in the unoccupied state (i.e., no food item is present within the cooking chamber). The controller may emit an alert after a first predetermined amount of time that the heating element is activate and the cooking chamber is in the unoccupied state. The first predetermined time may be any suitable length of time, for example 15 minutes, for example 10 minutes, for example 5 minutes. The alert may be any suitable alert. For instance, a control panel of the oven appliance may emit a certain tone or series of tones to the user. Additionally or alternatively, the oven light may flash in a predetermined pattern. Additionally or alternatively, the control panel may display a warning message.

The cooking operation may include deactivating the heating element after a second predetermined amount of time. The second predetermined amount of time may be measured from the time that the controller emits the alert. The second predetermined amount of time may be any suitable length of time, for example 20 minutes, for example 15 minutes, for example 5 minutes. Accordingly, the controller may automatically deactivate the heating element (or elements) when it is determined that no food item is present within the cooking chamber (i.e., the cooking chamber is in the unoccupied state). Thus, the cooking chamber is not heated unnecessarily, and energy costs may be saved.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a cabinet defining a cooking chamber;
a door configured to open and close the cooking chamber;
a heating element configured to provide heat to the cooking chamber;
a camera directed at the cooking chamber; and
a controller operably connected to the camera, wherein the controller is configured to initiate a cooking operation, the cooking operation comprising
determining that the door is in a closed position,
capturing a first image of the cooking chamber using the camera,
determining an occupied state of the cooking chamber based on the first image, and
initiating a timer sequence upon determining the occupied state of the cavity.

2. The cooking appliance of claim 1, wherein the cooking operation further comprises
determining movement of the door from an open position to the closed position;
capturing a second image of the cooking chamber using the camera based on determining movement of the door from the open position to the closed position;
determining an unoccupied state of the cooking chamber following determining the occupied state; and
stopping the timer sequence upon determining the unoccupied state of the cooking chamber.

3. The cooking appliance of claim 2, wherein the cooking operation further comprises
determining movement of the door from the open position to the closed position;
capturing a third image of the cooking chamber using the camera after the door is in the closed position;
determining the occupied state of the cooking chamber following determining the unoccupied state; and
reinitiating the timer sequence in response to determining the occupied state of the cooking chamber.

4. The cooking appliance of claim 1, wherein the determining the occupied state of the cooking chamber comprises analyzing the first image using a neural network.

5. The cooking appliance of claim 1, wherein the cooking operation further comprises
determining absence of a user-selected cook time for the timer sequence following initiating the timer sequence; and
wherein the timer sequence comprises a count-up sequence in response to determining absence of a user-selected cook time.

6. The cooking appliance of claim 5, wherein the cooking operation further comprises
receiving a selected cook time following determining absence of the user-selected cook time; and
reducing, automatically, the selected cook time based on the count-up sequence.

7. The cooking appliance of claim 6, wherein the cooking operation further comprises starting the reduced selected cook time in the timer sequence in response to receiving the selected cook time.

8. The cooking appliance of claim 1, further comprising an oven light provided within the cooking chamber, wherein the cooking operation further comprises illuminating the oven light in response to determining the occupied state of the cooking chamber.

9. The cooking appliance of claim 1, wherein the cooking operation further comprises
determining that the heating element has been activated;
capturing a second image of the cooking chamber using the camera in response to determining that the heating element has been activated;
determining an unoccupied state of the cooking chamber based on the second image; and
emitting an alert in response to expiration of a first predetermined amount of time following determining of the unoccupied state of the cooking chamber.

10. The cooking appliance of claim 9, wherein the cooking operation further comprises deactivating the heating element after a second predetermined amount of time following emitting the alert.

11. A method for operating a cooking appliance comprising a cooking chamber and a camera within the cooking chamber, the method comprising:
determining that a door of the cooking chamber is in a closed position;
capturing a first image of the cooking chamber using the camera;
analyzing the first image;
determining an occupied state of the cooking chamber based on the first image; and
initiating a timer sequence upon determining the occupied state of the cooking chamber.

12. The method of claim 11, further comprising:
determining movement of the door from an open position to the closed position;
capturing a second image of the cooking chamber using the camera based on determining movement of the door from the open position to the closed position;
determining an unoccupied state of the cooking chamber following determining the occupied state; and
stopping the timer sequence upon determining the unoccupied state of the cooking chamber.

13. The method of claim 12, further comprising:
determining movement of the door from the open position to the closed position;
capturing a third image of the cooking chamber using the camera based on determining movement of the door from the open position to the closed position;
determining the occupied state of the cooking chamber following determining the unoccupied state; and
reinitiating the timer sequence in response to determining the occupied state of the cooking chamber.

14. The method of claim 11, wherein the determining the occupied state of the cooking chamber comprises analyzing the first image using a neural network.

15. The method of claim 11, further comprising determining absence of a user-selected cook time for the timer sequence following initiating the timer sequence; and wherein the timer sequence comprises a count-up sequence in response to determining absence of a user-selected cook time.

16. The method of claim 15, further comprising:
receiving a selected cook time following determining absence of the user-selected cook time; and
reducing, automatically, the selected cook time based on the count-up sequence.

17. The method of claim 16, the cooking operation further comprises starting the reduced selected cook time in the timer sequence in response to receiving the selected cook time.

18. The method of claim 11, wherein the cooking appliance further comprises an oven light provided within the cooking chamber, and wherein the method further comprises illuminating the oven light in response to determining the occupied state of the cooking chamber.

19. The method of claim 11, further comprising:
determining that a heating element of the cooking appliance has been activated;
capturing a second image of the cooking chamber using the camera in response to determining that the heating element has been activated;
determining an unoccupied state of the cooking chamber; and
emitting an alert in response to expiration of a first predetermined amount of time following determining the unoccupied state of the cooking chamber.

20. The method of claim 19, further comprising deactivating the heating element after a second predetermined amount of time following emitting the alert.
